(19) United States
(12) Patent Application Publication
(10) Pub. No.: US 2022/0083943 A1
(43) Pub. Date: Mar. 17, 2022

(54) SYSTEMS AND METHODS FOR ORDER FULFILLMENT, COMMON ORDER PACK LISTS, MULTI-ITEM ORDER PACKING, AND SHIPPING RATE AUTOMATION

(71) Applicant: Soapbox SaaS, Inc., West Covina, CA (US)

(72) Inventors: Danny He, West Covina, CA (US); Jordan Phillips, West Covina, CA (US)

(21) Appl. No.: 17/476,374

(22) Filed: Sep. 15, 2021

Related U.S. Application Data
(60) Provisional application No. 63/079,227, filed on Sep. 16, 2020.

(51) Int. Cl. G06Q 10/06; G06Q 10/08; G06K 15/02; B65B 59/00

(52) U.S. Cl. CPC G06Q 10/06313; G06Q 10/0875; G06Q 10/06315; G06Q 10/08345; G06K 15/1803; B65B 59/003; G06Q 2250/70; G06Q 10/0838

(57) ABSTRACT

Embodiments of the present disclosure provide improved methods, techniques, and processes, often computer-based, for fulfilling commerce orders (e.g., e-commerce orders), such as automated generation of, among other things, (1) pack lists organized by “common order” number, (2) optimized packaging and shipping carrier recommendations, and (3) shipping labels.

This application claims the priority benefit of U.S. Provisional Application No. 63/079,227 to He et al., filed on Sep. 16, 2020 and entitled “Systems and Methods for Order Fulfillment, Common Order Pack Lists, Multi-Item Order Packing, and Shipping Rate Automation,” the entire contents of which are hereby incorporated by reference.

### BACKGROUND OF THE DISCLOSURE

### Field of the Disclosure

The present disclosure relates to methods and systems for commerce order fulfillment, such as methods and systems for fulfilling and shipping e-commerce orders. Specifically, the present disclosure relates to order fulfillment using a common order method and/or common order pack lists, and to systems and methods related to packaging and shipping recommendations for orders such as e-commerce orders.

### Description of the Related Art

Several methods and processes exist for commercial businesses performing e-commerce operations related to customer order fulfillment and shipment preparation, which can include preparing a pick and/or pack list to pick and manage the items shipped, choosing packaging, shipping carrier and rate, and printing shipping labels. Pick lists typically identify all of the items within all of the orders that need to be pulled to fulfill the orders. Pack lists typically identify all of the orders and the items included within each order. Pick or pack lists also typically include details such as order number, quantity of each item(s), and ship-to address. Customer orders are often organized by order number on a pack list, with order numbers generally sequential based on timing of the receipt of that order (e.g., Order No. 1, Order No. 2, Order No. 3, etc.).

Businesses may use computer or software applications to manually create their pick and/or pack lists and shipping labels, such as word processors or special-purpose shipping label applications. Using a word processor to prepare pick and/or pack lists and shipping labels is an error prone process, as relevant information (e.g., each destination shipping address) is entered manually. In addition, the word processor may not be configured or otherwise capable of preparing bar codes or other machine-readable indicia required or preferred by some carrier services. Manually-created pick and/or pack lists leave room for further user error, such as typographical errors in the ship-to address, item ordered, or quantity ordered.

Businesses typically pick and pack customer orders for shipping based on a pack list. Users may, in some instances, choose not to prepare the orders sequentially based on order number. Users typically have discretion on which packaging is used for each order, and then have to confirm the contents of each package individually with the order details on the pack list. The user then generates individual shipping labels based on the weight and dimensions of each order package.

Manually ensuring consistency of the data between the shipping label, pack list, and the contents of the actual package results in wrong orders or packages shipped out, additional costs to the commercial business, and unhappy customers. Manually inputting weight and dimension data during shipping label generation may result in incorrect data entry, in turn resulting in additional shipping fees, surcharges, and/or costs. Additionally, to create a shipping label, a user has to manually shop for shipping rates across different carriers and choose which rate to use based on the package, or simply proceed with a single carrier regardless of whether that carrier has the best rate available.

There is also the method of batch (mass) selection for packaging and shipping customer orders where package dimensions and weight are assumed as one standard size and one negotiated rate is used through one shipping service. Using this method, businesses will pay a special handling fee for any oversized or incorrect shipping fees. This can result in approximately 40% more in shipping costs.

Labels are generally unsorted, but they might be printed in the same order as the order numbers on the pack list. Users then have to physically match the label to the orders on the list, and then match the orders on the list to the packages before affixing the label to the corresponding packages. Then, the users need to sort the packages with shipping labels affixed by shipping carriers, which takes additional time and increases the chances of error.

The prior art manual processing and validation greatly extends fulfillment times for customer orders, introduces a multitude of opportunities for error, and increases overall costs.

### SUMMARY OF THE DISCLOSURE

The present disclosure provides various embodiments of methods and systems for a common order method of order fulfillment, and for generation of a common order pack list. The present disclosure also provides methods and systems for optimized packing and shipping recommendations for businesses fulfilling orders such as e-commerce orders.

One embodiment of a method for packing commerce orders for fulfillment according to the present disclosure includes receiving an order, grouping the order with other pending orders with the same item(s) and quantities, and assigning each group to a common order number. The method further includes creating a common order pack list organized by common order number. Additional possible steps may include gathering items for the pending orders using the pack list, and/or packing the items using the common order pack list.

One embodiment of a method for optimizing packaging and shipping for commerce orders for fulfillment according to the present disclosure includes inputting information about available packaging, inputting information about items available for ordering, receiving at least one order for at least one item, and performing at least one calculation involving the volume and/or dimensions of the at least one item. Additional possible steps may include inputting the dimensions of available packaging and the amount of packaging in stock, and/or inputting the dimensions of items available for ordering and the number of items in stock.

One embodiment of a system for fulfilling commerce orders according to the present disclosure includes at least one marketplace where customers can place orders for at least one item, and one or more hardware computing devices having a processor and memory to receive those orders from the marketplaces. The system further includes software that generates common order pack lists organized by common order number and containing optimized packaging and shipping recommendations for the common order numbers.

A better understanding of the features and advantages of the present embodiments will be obtained by reference to the following detailed description of the disclosure and accompanying drawings which set forth illustrative embodiments in which the principles of the disclosure are utilized.

### BRIEF DESCRIPTION OF THE DRAWINGS

FIG. 1 shows an overview flow diagram of a common order packing method and creation of a common order pack list, according to one embodiment of the present disclosure;

FIG. 2 is a graphic representation of one embodiment of a common order pack list according to the present disclosure;

FIG. 3 is a graphic representation of an exemplary embodiment of a shipping label according to the present disclosure;

FIG. 4 shows an overview flow diagram of a method for optimizing packaging and/or shipping for commerce orders for fulfillment according to one embodiment of the present disclosure;

FIG. 5 is a graphic representation of one embodiment of a user interface according to the present disclosure;

FIG. 6 is a graphic representation of another embodiment of a user interface according to the present disclosure; and

FIG. 7 is a graphic representation of yet another embodiment of a user interface according to the present disclosure.

### DETAILED DESCRIPTION OF THE DISCLOSURE

Embodiments of the present disclosure provide improved methods, techniques, and processes, often computer-based, for fulfilling customer orders (e.g., e-commerce orders), such as automated generation of (1) pack lists organized by “common order” number, (2) optimized packing, packaging, and shipping carrier recommendations, and (3) shipping labels. Embodiments of the present disclosure also greatly reduce order fulfillment times and costs for businesses by providing pre-validated packaging selection and shipping rate shopping. Some embodiments of the systems and methods described herein can result in the generation of labels (e.g. pre-paid shipping labels) with common order numbers.

The present disclosure will now set forth detailed descriptions of various embodiments. Many of the methods described below may be implemented with computer software and/or hardware, such as computers, processors, smart devices (e.g. smart phones), tablets, memory, processors, computer readable medium, computer executable instructions, algorithms, and/or similar. The methods herein can be performed at least in part using software, software as a service (SAAS) technology, platform as a service (PARS) technology, infrastructure as a service (IAAS) technology, and/or other technologies as would be understood by one of skill in the art.

In the description that follows, numerous details are set forth in order to provide a thorough understanding of the disclosure. It will be appreciated by those skilled in the art that variations of these specific details are possible while still achieving the results of the disclosure. Well-known elements and processing steps are generally not described in detail in order to avoid unnecessarily obscuring the description of the disclosure.

Throughout this description, the preferred embodiments and examples illustrated should be considered as exemplars, rather than as limitations on the present disclosure. As used herein, the terms “invention,” “disclosure,” “method,” “present invention,” “present disclosure,” “present method,” or similar terms refer to any one of the embodiments of the disclosure described herein, and any equivalents. Furthermore, reference to various feature(s) of the “invention,” “disclosure,” “method,” “present invention,” “present disclosure,” “present method,” or similar terms throughout this document does not mean that all claimed embodiments or methods must include the referenced feature(s).

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The steps described in the below methods may be performed in different orders than those specifically described, as would be understood by one of skill in the art. Some steps may be performed simultaneously and/or continuously, as would be understood by one of skill in the art.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” “including,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to flowcharts are schematic illustrations of embodiments of the disclosure. As such, the arrangements of components or steps can be different, and variations are expected. Additionally, components and steps shown as a singular component or step may include multiple components or substeps, while aspects shown as multiple components or steps may be a singular component or performed as a singular step. Embodiments of the disclosure should not be construed as limited to the particular arrangements, components, or steps.

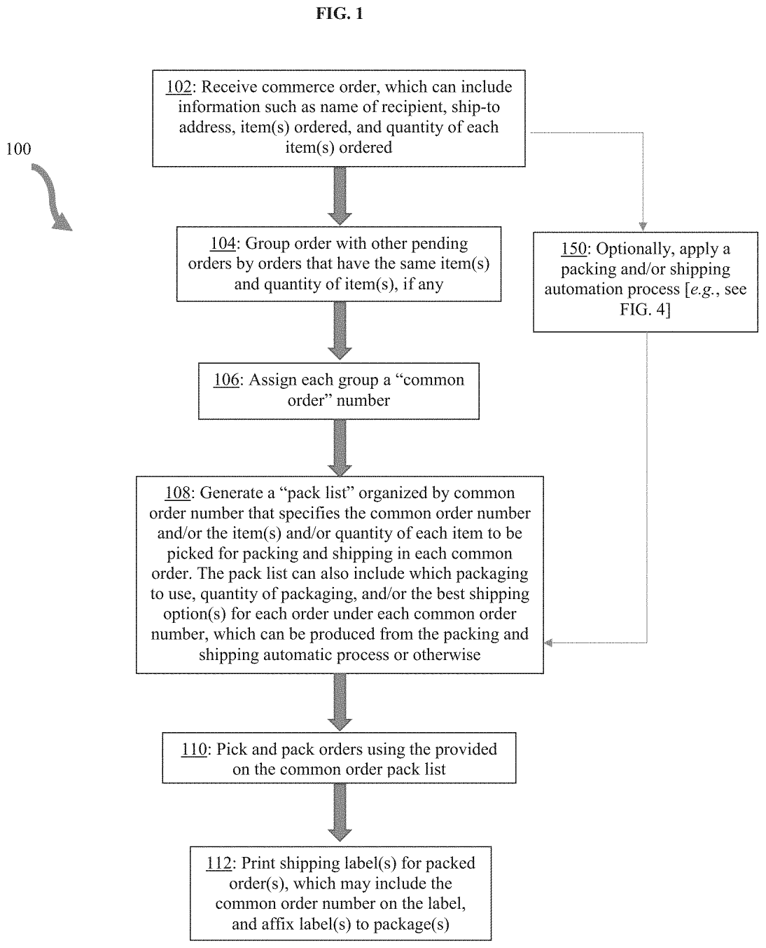

FIG. 1 is an exemplary flowchart showing one embodiment 100 of a common order picking and packing method and generation of a common order pack list. Taking customer order information received by the business (step 102), in step 104 orders are grouped with other pending orders that have the same items and quantity of items, if any (though other embodiments are possible, such as groups that have the same item(s) but not necessarily the same quantity of each item). Each group is assigned a common order number (step 106) and, using the common order number, a list (referred to herein as a “common order pack list”) can then be created (whether that list is a physical list, a digital list, or otherwise, and whether or not a user can actually view that list) (step 108). In some embodiments, the common order pack list is organized by shipping carriers in addition to common order number.

The common order pack list can created manually or can be computer-generated. The automated generation of the common order pack list can be triggered manually by the user, or generated otherwise. The common order pack list, in some embodiments, may be generated automatically at certain time intervals. The common order pack list can, in some embodiments, also be under constantly and/or automatically updated, with a user able to take a “snapshots” of the current common order pack list at various times. Many different embodiments are possible.

While these steps are shown in FIG. 1 in a specific order, as described above and as with other methods described herein, they may be performed in a different order, and/or simultaneously, and/or continuously. By way of a specific example that is in no way limiting, a common order number is often assigned (step 106) prior to another order coming in and that order being assigned that same common order number because it has the same type and/or quantity of items (step 104).

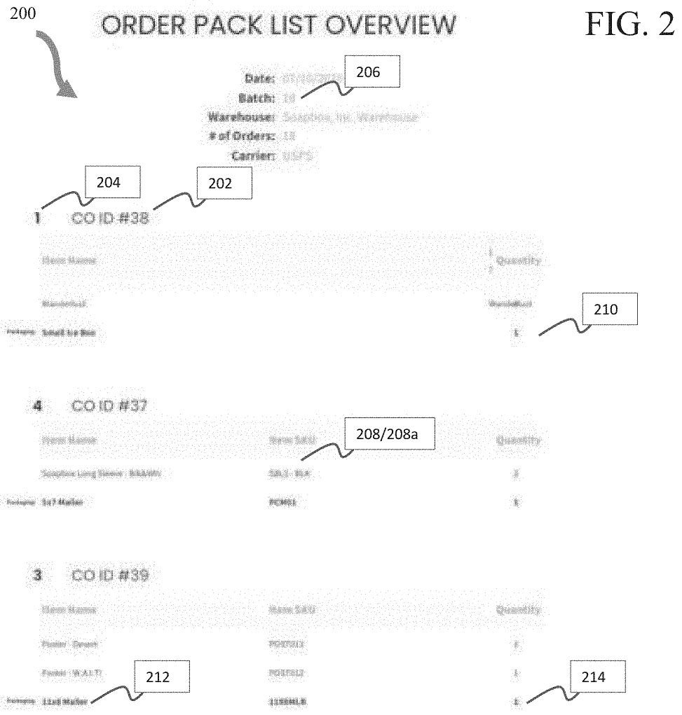

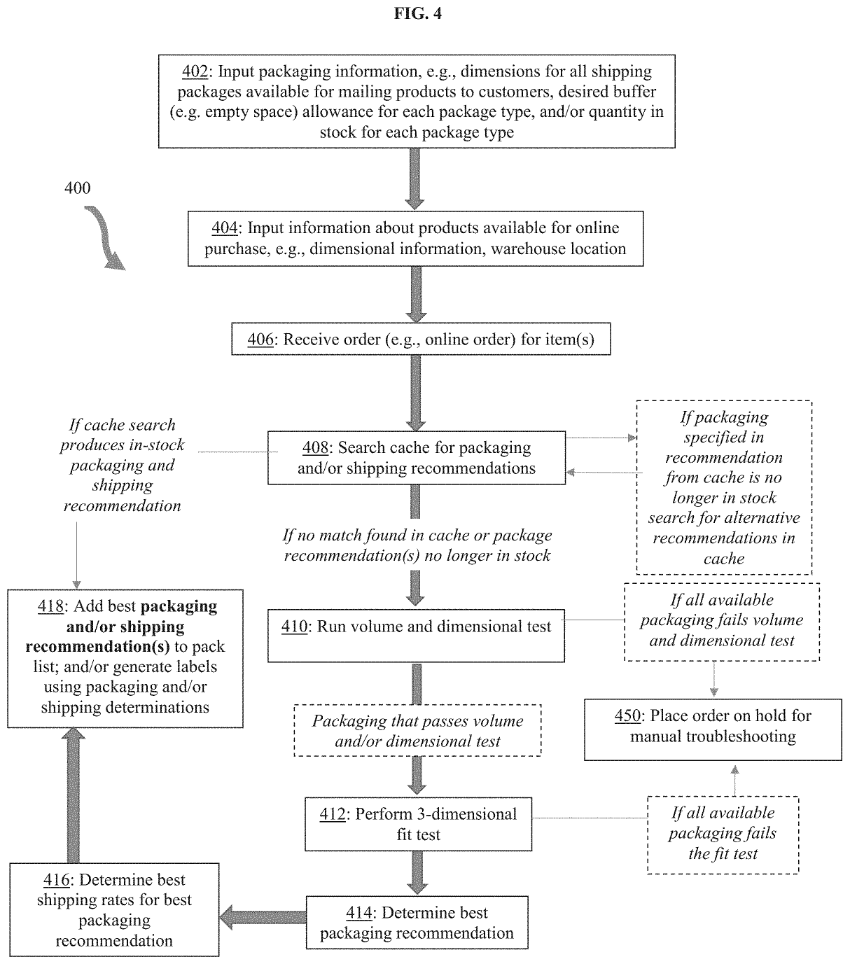

FIG. 2 shows one embodiment of a common order pack list 200 according to the present disclosure, which can be organized by common order number. The common order pack list 200 can specify each common order number 202, and can also include other information such as, for example, the quantity 204 of each common order number that have been ordered, the batch number 206 (each “batch” may be trigger manually, such as when a user is ready to fulfill orders, or automatically, such as on a pre-set schedule), the item(s) 208 (and/or an indicator of the item such as a SKU 208a or other item code, such as a barcode) and quantity 210 of each item to be picked for shipping for each common order, recommended packaging 212 (which may be based on available packaging), quantity of packaging 214, and/or the best shipping option for each common order group (e.g., from the process shown in FIG. 4 and discussed in detail below). Other information, such as but not limited to that included in the FIG. 2 example, can be included. The packaging recommendations can be generated using a packing and/or shipping automation process, such as the embodiment shown in FIG. 4 and described in detail below.

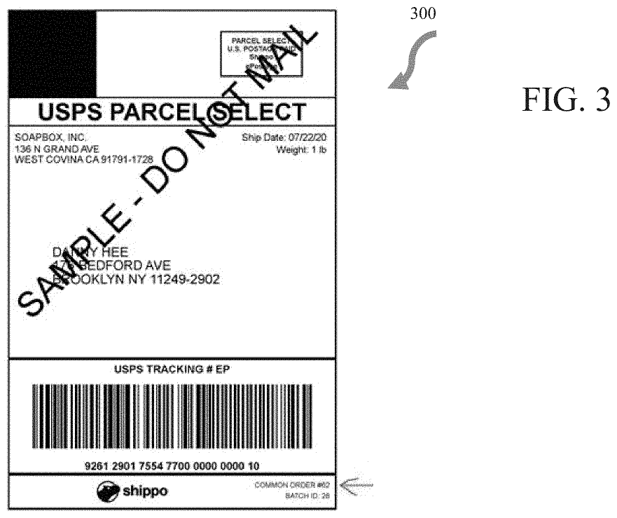

Referring back to FIG. 1, after the common order pack list is generated, each customer order can be picked and packed using it (step 110). In some embodiments, shipping labels can also be generated (e.g., printed) using the common order pack list and then affixed to the appropriate package (step 112). FIG. 3 shows one example of a shipping label 300 that can be produced using methods and systems according to the present disclosure. In addition to typical shipping information, the generated label can include additional information such as common order number and/or batch number. Shipping labels printed with common order numbers to match the common order pack list greatly reduce mistakes, such as those caused by manual data entry, while also reducing the overall amount of manual effort and cost involved. These labels can be affixed to the packages, and at that point can be ready for shipping.

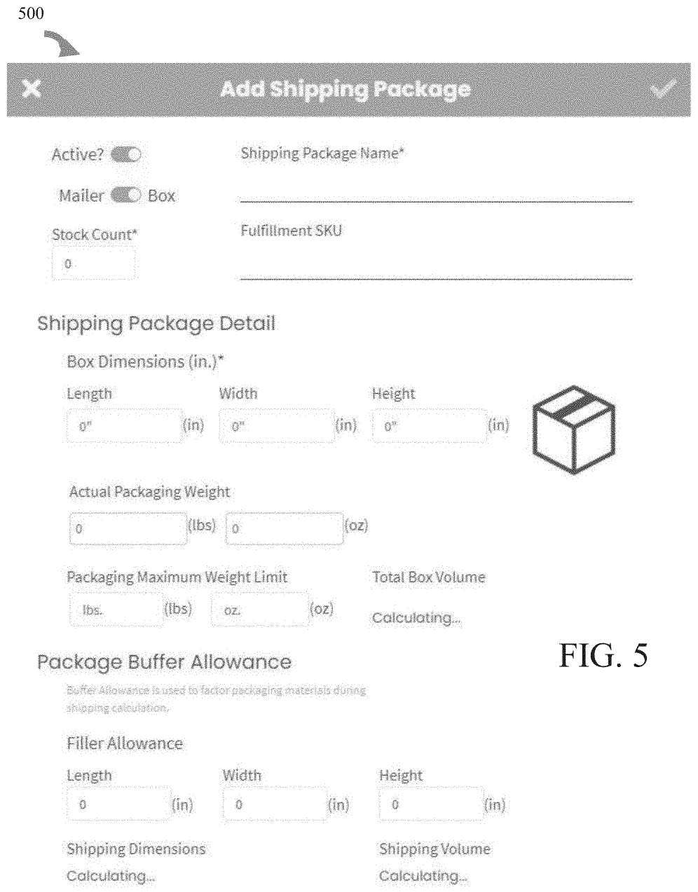

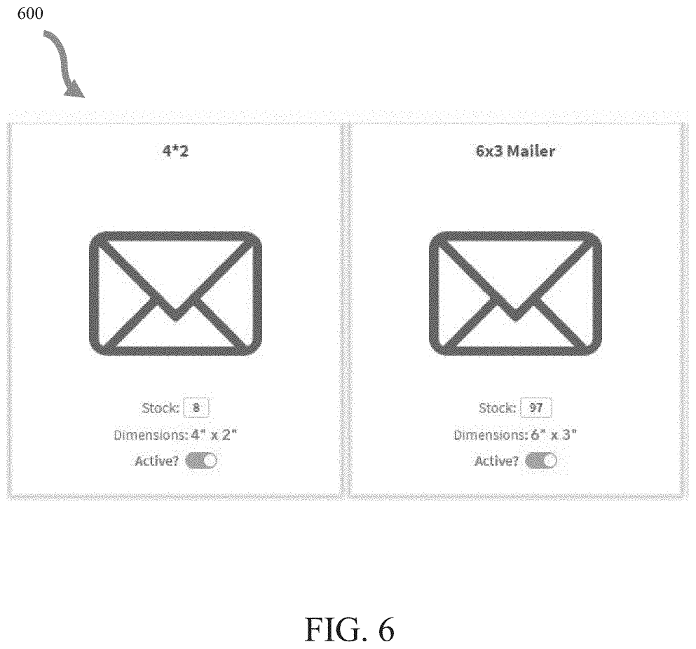

FIG. 4 is an exemplary flowchart showing one embodiment of a method for optimizing packaging and shipping for commerce orders for fulfillment 400. The method 400 can be applied, for example, to e-commerce order fulfillment. In step 402, information can be input (e.g., manually by a user, or otherwise) about all packaging available for mailing items to recipients, which can include each package type's dimensions, weight, desired buffer allowance (i.e., desired empty space within the package), and/or current inventory of the packaging. Many different characteristics and inputs are possible. FIG. 5 depicts one embodiment of a user interface 500 for shipping package information input. After input, inventory of types of packaging can be updated manually, or can be automatically tracked based on what packaging has been used for shipping. FIG. 6 depicts one embodiment of a user interface 600 for stock count of packaging supply.

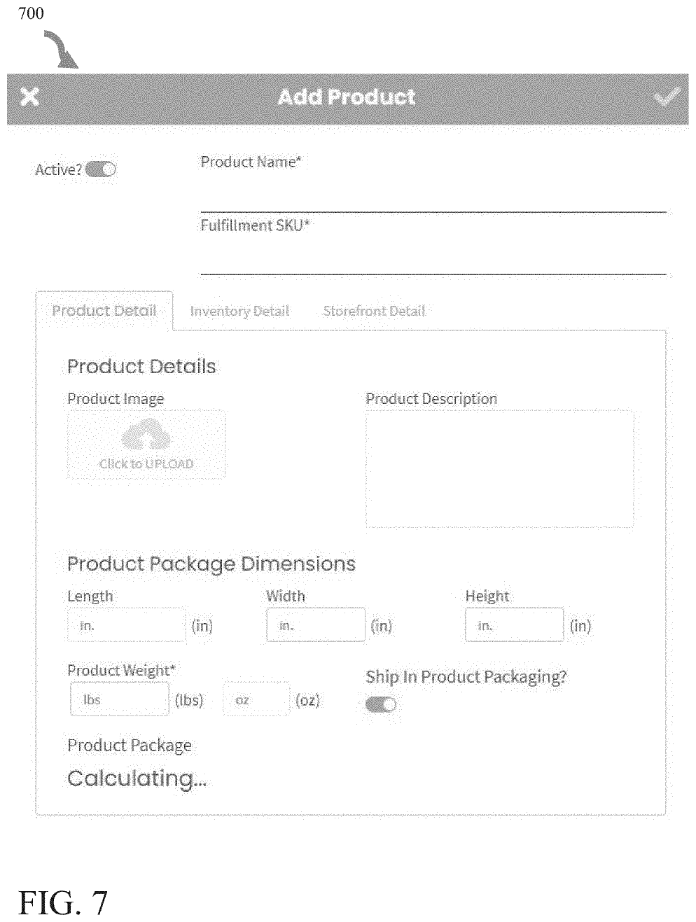

In step 404, information can be input (e.g., manually by a user, or otherwise) about each item that is available to be shipped, such as the item's dimensions and weight of the item. If the item is to be shipped in its item packaging (e.g., the item comes in the manufacturer's box, and the entire manufacturer's box is to be placed in the shipping packaging), then information regarding the item packaging can be input. In some embodiments, the item can be marked as being delicate or fragile, which can be used in determining the type of item packaging to be used and may result in a different packaging being recommended than for a non-delicate item. FIG. 7 depicts one embodiment of a user interface 700 for item information input. The input information can include, for example, item name, indicator (e.g., SKU, barcode, etc.), image, description, dimensions, inventory, and/or weight. Many different inputs are possible. If inventory is input, it can be tracked and updated manually, or can be automatically tracked based on what items have been ordered and/or shipped.

When the business receives an order (e.g., e-commerce order), information from that order, which can include the item purchased and the quantity of each item purchased, can be used to generate an optimized packaging and shipping recommendation. This recommendation generation can in some embodiments be performed by hardware and/or software as previously described. In step 408, a search of a cache (which can be maintained from previous orders) can be performed to see if the exact same item or combination of items has previously been ordered; if so, then the packaging used for the previous order can be recommended for the current order. If the recommended packaging is not available (e.g., because it is out of stock), then another search of the cache can be performed for a secondary recommendation based on previously-used packaging recommendations.

If the cache search does not result in a match or no stock remains of the packaging recommendation(s) from the cache (or in embodiments not utilizing a cache search), then in step 410 a packaging test to calculate a packaging recommendation can be performed. It is understood that step 410 can be performed even if no cache test is performed, and the cache test can be completely omitted. The total volume and/or dimensions of the items in the order can be calculated, such as by using space optimization software or algorithms in order to calculate the packing organization resulting in the lowest total volume. Other parameters can also be used in this calculation; e.g., if the order needs to fit in packaging with an overall depth of 1″ or less, then this fact can be used as an input in the calculation such that the result will meet this criterion. The output optimized volume can then be compared to the types of packaging available to determine which types of packaging are suitable for the order. Then, the dimensions of the optimized volume can be compared to the available packaging to determine which packaging meets both the volume and dimension requirements. It is understood that the volume and dimension tests can be performed in any order (and/or simultaneously), or in some embodiments, only one of them might be used.

If a package fails either step, then the package can be excluded from the recommendation. These steps are run on the packaging available until a package does not fail both steps in some embodiments, and in some embodiments are run on all available packaging. If all packages available to the business fail the test, the order can be placed on hold to be manually addressed by a user (step 450).

In step 412, a virtual three-dimensional (3D) rendering tool can then be used by the algorithm to determine how the item(s) will fit into the packaging that has passed the above test. The rendering tool can be used only on the most optimal package as determined by the dimensional/volume test(s), or can be performed on all packages that passed the dimensional/volume test(s). This determination is critical for e-commerce orders with multiple items. The rendering tool can be operated manually by a user, or automatically, such as by using algorithms or artificial intelligence. If the item(s) ordered will not fit in the packaging, then that package will be excluded. The results of the fit test can be used when actually packing the ordered items, to ensure that they are packed in the manner recommended by the fit test.

Since some packaging (e.g., mailers) are commonly measured with two dimensions instead of three dimensions, in one embodiment, the method can generate and/or utilize a third dimension for the packaging, effectively making a three-dimensional object. Use of the third dimension allows the volume, dimension, and fit tests shown in steps 410 and 412 to be performed accurately.

In one embodiment, the packaging that is ultimately recommended to the user to use in fulfilling an e-commerce order (step 414) is one that (1) has passed the two-step packaging test (the dimension portion can in certain embodiments be omitted for multi-item orders, or can be included), (2) has passed the 3D rendering tool calculations (which can be omitted for single-item orders in certain embodiments, or can be included), and (3) will have the least amount of empty space in the packaging after the item(s) are placed in it. In another embodiment, the third criterion is determining the cheapest type of packaging available for the item(s). In another embodiment, these two criteria can be combined with one another (e.g., the cheapest packaging that has under a certain amount of empty space, or the packaging that has the least amount of empty space and also costs under a certain amount to ship). Many different embodiments are possible.

Optionally, in step 416, after recommended packaging has been determined, a search can be performed (manually or using an internet or other electronic search tool) to determine the cheapest carrier for the recommended packaging. Additional criteria, such as maximum shipping time and/or arrival deadline, can be used in this determination. The cheapest carrier can then be output as recommended shipping information.

In some embodiments, a user can override packaging and/or shipping recommendations, or user preference (whether manually input or algorithm-based, such as based on a user's previous usage or preferences) may be included as part of the suitability calculation. In some embodiments, secondary recommendations can be made and/or the user can manually select packaging and/or shipping. Final packaging and/or shipping information produced by any of these methods and variations thereof can be included on a common order pack list and/or can be used as an input in generating a shipping label or similar, such as the shipping label 300 shown in FIG. 3 (step 418). Final packaging and/or shipping information produced by any of these methods and variations thereof can be added to the cache.

In some embodiments, a forecasting tool can be used to analyze order history of a business and make recommendations on packaging that the business should use. The analysis results in several packaging options for future orders that the user should purchase. Using these recommendations, businesses can purchase packaging catered to their exact order history, preventing over-ordering of supplies or ordering of unnecessary oversized packaging, resulting in further cost-savings.

The present disclosures allows the user to pick, pack, and ship customer orders efficiently and in a manner that minimizes manual error. Users can eliminate the manual data check between shipping label, common order pack list, and actual package because all data is organized by common orders on both the common order pack list and the label, rather than individual order number. This eliminates standard data points from a common order pack list used to manually match labels to the common order pack list to customer orders in favor of a pre-matched common order management system.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Furthermore, certain terminology has been used for the purposes of descriptive clarity, and not to limit the present disclosure. It is therefore intended that the following appended claims include all such alterations, modifications and permutations as fall within the true spirit and scope of the present disclosure.

It is understood that embodiments presented herein are meant to be exemplary. Embodiments of the present disclosure can comprise any combination of compatible features shown in the various figures, and these embodiments should not be limited to those expressly illustrated and discussed. Moreover, it is understood that the below appended claims could be rewritten as multiple dependent claims, and/or dependent claims could be rewritten so as to depend from a different independent claim.

Although the present disclosure has been described in detail with reference to certain preferred configurations thereof, other versions are possible. Therefore, the spirit and scope of the disclosure should not be limited to the versions described above.

1. A method for packing commerce orders for fulfillment comprising:
receiving an order;
grouping said order with other pending orders with the same item(s) and quantities;
assigning each group a common order number; and
creating a common order pack list organized by said common order numbers.

2. The method of claim 1, further comprising:
gathering items for said pending commerce orders using said common order pack list.

3. The method of claim 1, further comprising:
packing said items picked using said common order pack list.

4. (canceled)

5. The method of claim 1, wherein said common order pack list comprises:
at least one common order number;
identification and quantity of items in each order organized under each common order number; and
the quantity of each common order number.

6. (canceled)

7. (canceled)

8. (canceled)

9. (canceled)

10. (canceled)

11. (canceled)

12. (canceled)

13. (canceled)

14. The method of claim 1, further comprising printing said common order pack list.

15. A method for optimizing packaging and shipping for commerce orders for fulfillment comprising:
inputting information about available packaging;
inputting information about items available for ordering;
receiving at least one order for at least one item;
performing at least one calculation involving the volume and/or dimensions of said at least one item; and
based on said at least one calculation, selecting optimized packaging for said order.

16. The method of claim 15, wherein said information about available packaging comprises amount of packaging in stock.

17. The method of claim 15, wherein said information about available packaging comprises dimensions of available packaging.

18. (canceled)

19. (canceled)

20. The method of claim 15, wherein said information about items available for ordering comprises dimensions of each item.

21. The method of claim 20, wherein one of the calculations involving order volume or dimensions comprises:
searching a cache that stores information on previous orders such as items, quantity of items ordered, packaging, and shipping, for the exact same item or combination of items; and
determining whether the packaging used in a previous matching order can be used for the current order.

22. (canceled)

23. The method of claim 15, wherein one of the calculation involving order volume or dimensions comprises:
calculating the lowest total volume of the items in the current order;
comparing said lowest total volume to the packaging available; and
determining which types of packaging fit the items in the current order.

24. The method of claim 23, further comprising:
comparing the dimensions of said lowest total volume to the available packaging; and
determining which packaging fits the dimensions and the volume of the items in the current order; and
packing said at least one item in said optimal package.

25. The method of claim 15, wherein one of the calculations involving order volume or dimensions comprises:
calculating the total volume of the items in the current order;
comparing the dimensions of said volume to the availability packaging; and
determining which packaging, if any, is the best fit for dimensions of the items in the current order.

26. (canceled)

27. (canceled)

28. (canceled)

29. (canceled)

30. (canceled)

31. (canceled)

32. (canceled)

33. (canceled)

34. (canceled)

35. (canceled)

36. The method of claim 15, further comprising generating a pre-paid shipping label for said order.

37. The method of claim 36, wherein said pre-paid shipping label comprises:
sender mailing information;
recipient mailing information; and
common order number.

38. The method of claim 15, further comprising packing said at least one item in said optimized packaging.

39. A system for fulfilling commerce orders, comprising:
at least one marketplace where customers can place orders for at least one item;
one or more hardware computing devices having a processor and memory to receive said orders from said marketplaces; and
software that generates common order pack lists that are organized by common order numbers and contain optimized packaging and shipping recommendations for said common order numbers.

40. The system of claim 39, further comprising:
a software program that generates optimized packaging and shipping recommendations for said common order numbers.

41. The system of claim 39, further comprising:
a software program that generates pre-paid shipping labels for said orders; and
a printer for printing said pre-paid shipping labels.

42. The system of claim 39, further comprising:
a software program that generates pre-paid shipping labels based on said optimized packaging and shipping recommendations.
